(19) United States
(12) Patent Application Publication
(10) Pub. No.: US 2010/0162411 A1
(43) Pub. Date: Jun. 24, 2010

(54) APPARATUS AND METHOD FOR MANAGING HYBRID CONTENTS GENERATED BY COMBINING MULTIMEDIA INFORMATION AND GEOSPATIAL INFORMATION

(75) Inventors: Yoonseop CHANG, Daejeon-city (KR); Kyungok Kim, Daejeon-city (KR); Seongho Lee, Daejeon-city (KR); Jaechul Kim, Daejeon-city (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon-city (KR)

(21) Appl. No.: 12/632,210

(22) Filed: Dec. 7, 2009

(30) Foreign Application Priority Data
Dec. 8, 2008 (KR) 10-2008-0124124
Sep. 8, 2009 (KR) 10-2009-0084527

(51) Int. Cl. G06F 12/14; G06F 17/21; G06F 17/00

(52) U.S. Cl. 726/27; 715/202; 715/235; 715/205

(57) ABSTRACT

An apparatus for managing hybrid contents generated by combining multimedia information and geospatial information includes an input/output unit that is connected with a contents storage and a contents using device to control input/output of the hybrid contents; a structure calculating unit that generates the hybrid contents having a layer structure using an XML format by interconnecting the multimedia information having the layer structure using the XML format provided from the input/output unit and the geospatial information having the layer structure using the XML format; and a relationship establishing unit that is connected with the input/output unit or the structure calculating unit to establish and provide the relationship of the multimedia information having the layer structure, the geospatial information having the layer structure, and the hybrid contents.

### RELATED APPLICATIONS

The present application claims priority to Korean Patent Application Serial Number 10-2008-0124124, filed on Dec. 8, 2008 and Korean Patent Application Serial Number 10-2009-0084527, filed on Sep. 8, 2009, the entirety of which are hereby incorporated by reference.

### BACKGROUND OF THE INVENTION

1. Field of the Invention

The present invention relates to an apparatus and a method for managing hybrid contents generated by combining multimedia information and geospatial information, and more particularly, to a technology capable of generating, controlling, and using hybrid contents which combine various multimedia information such as a plan photo, a cubic photo, a space photo, a sequence photo, or the like and geospatial information such as a direction, an angle, a distance, a trajectory, a panorama configuration, etc. on the basis of an XML technology and efficiently using the hybrid contents by defining a relationship (note, magnification, overlay, etc) between the hybrid contents and a text or an image or another hybrid contents.

2. Description of the Related Art

As wired and wireless communication networks including the Internet, a portable multimedia player (PMP), a netbook, a mobile phone, etc. are expanded, and a service industry and a media industry that use the wired and wireless communication networks are developed, a technology for a multimedia industry is being actively developed. In particular, technologies for a search for delicious restaurants and a search for geographic information are being actively utilized by using a mobile communication network or the communication networks and with development of a communication network, a search service for geospatial information using Internet portal sites, etc. is being rapidly expanded.

In the state where a hybrid information providing service providing geospatial information in addition to an image for a location which a user wants to search has already been commercialized in various Internet sites on the basis of the communication networks such as the Internet, etc., the geospatial information search service provides a technology of providing positional information of media to multimedia devices such as a camera, etc. by using a GPS, a technology of expressing the location by searching geospatial information of an image and searching a panorama image or a plurality of images of the same space to combine the panorama image or the images with the geospatial information, and a technology of providing a blog service on the basis of the technology.

However, since most of the technologies include a technology of simply combining geographical information with still images of the camera by mounting a GPS satellite receiving device or a technology of using a hypertext markup language (HTML) on the basis of a Web service for searching and expressing the still images or moving pictures, the technologies are difficult to be applied to a mobile communication terminal, other communicable multimedia display device, or the like and the technologies cannot support processing structured data such as a database, such that there is a problem in processing a hybrid multimedia structure and a hybrid contents structure combining the geospatial information with the hybrid multimedia structure.

Therefore, in the related art, a technology of an integrated hybrid contents structure which can combine geospatial information such as information of a predetermined area with the moving picture or a sequence geological photo acquired by photographing the predetermined road along a predetermined road in addition the still images is insufficient. In addition, in the related art, a function to describe the hybrid contents such as the annotation, magnification, overlay, etc. by connecting the text, the image, or another hybrid contents to the integrated hybrid contents cannot also be performed as one control structure.

### SUMMARY OF THE INVENTION

In order to solve the above-mentioned problems, the technology provides a technology of allowing a user to arbitrarily operate a structured database structure even in a web page and generating, controlling, and using hybrid contents which combine geospatial information corresponding to the multimedia data and having a database layer structure with hybridically layer structured multimedia data by using an extensible markup language (XML) which can be accessed even through other communication terminals in addition to the web page and in addition, has an object to allow the user to more efficiently and conveniently access an use the combination contents of the multimedia and the geospatial information, and improve efficiency and compatibility in controlling the combination contents by integrally implementing functions such as annotation, magnification, overlay, etc. using the hybrid contents structure by using the above-mentioned XML layer structure or the structured database.

In order to achieve the above-mentioned object, an apparatus for managing hybrid contents generated by combining multimedia information and geospatial information includes an input/output unit that is connected with a contents storage and a contents using device to control input/output of the hybrid contents; a structure calculating unit that generates the hybrid contents having a layer structure using an XML format by interconnecting the multimedia information having the layer structure using the XML format provided from the input/output unit and the geospatial information having the layer structure using the XML format; and a relationship establishing unit that is connected with the input/output unit or the structure calculating unit to establish and provide the relationship of the multimedia information having the layer structure, the geospatial information having the layer structure, and the hybrid contents.

Further, a method for managing hybrid contents generated by combining multimedia information and geospatial information includes allowing a contents control unit to receive multimedia information having a layer structure using an XML format and geospatial information having a layer structure using the XML format from a contents storage; generating the hybrid contents which combine the multimedia information having the layer structure and the geospatial information having the layer structure; allowing the contents control unit to input/output the hybrid contents with the contents storage or a contents using device; and allowing the contents control unit to establish the relationship of the multimedia information having the layer structure, the geospatial information having the layer structure, and the hybrid contents.

According to an embodiment of the present invention, in an apparatus and a method for managing hybrid contents generated by combining multimedia information and geospatial information, it is possible to conveniently combine layer-structured multimedia information and layer-structured geospatial information and control the structure by controlling and providing of a database of the hybrid contents which integrally combine the multimedia information and the geospatial information on the basis of an XML format, it is possible to improve a usage range as the hybrid contents and efficiency in controlling the contents, provide a standard for the hybrid contents, and provide an efficient and convenient technology to both a control unit and the user by providing a wide usage range (used terminal and used service type) while providing an integrated control service of the hybrid contents to the user.

### BRIEF DESCRIPTION OF THE DRAWINGS

FIG. 1 is a diagram showing an apparatus for managing hybrid contents generated by combining multimedia information and geospatial information according to an embodiment of the present invention;

FIG. 2 is a diagram showing devices constituting a structure calculating unit of a contents control unit;

FIG. 3 is a diagram showing a database structure of multimedia according to an embodiment of the present invention;

FIG. 4 is a diagram showing a geospatial information structure according to an embodiment of the present invention;

FIG. 5 is a diagram showing the structure of hybrid contents which combine multimedia information having a layer structure and geospatial information having a layer structure generated according to an embodiment of the present invention;

FIG. 6 shows an example of a cubic photo in a multimedia structure;

FIG. 7 shows an exemplary diagram of the type of a sequence geophoto in a multimedia structure;

FIG. 8 shows an exemplary diagram of the type of a surround geophoto in a multimedia structure;

FIG. 9 is a diagram showing devices constituting a relationship establishing unit of a contents control unit;

FIG. 10 is a configuration diagram of a relationship control unit of a relationship establishing unit;

FIG. 11 is a configuration diagram of a content entity establishing unit of a relationship establishing unit;

FIG. 12A shows an example of establishing the relationship of an image annotation entity by using a point-to control unit and an enlargement control unit;

FIG. 12B shows an example of establishing the relationship of a text annotation entity by using a point-to control;

FIG. 12C shows an example of establishing the relationship by using a hyperlink control;

FIG. 13A shows an example of a screen of a control system using an apparatus for managing hybrid contents according to an embodiment of the present invention;

FIG. 13B shows an example of a screen of a contents using system through an apparatus for managing hybrid contents according to an embodiment of the present invention; and

FIG. 13C shows another example of a screen of a contents using system through an apparatus for managing hybrid contents according to an embodiment of the present invention.

### DETAILED DESCRIPTION OF THE PREFERRED EMBODIMENTS

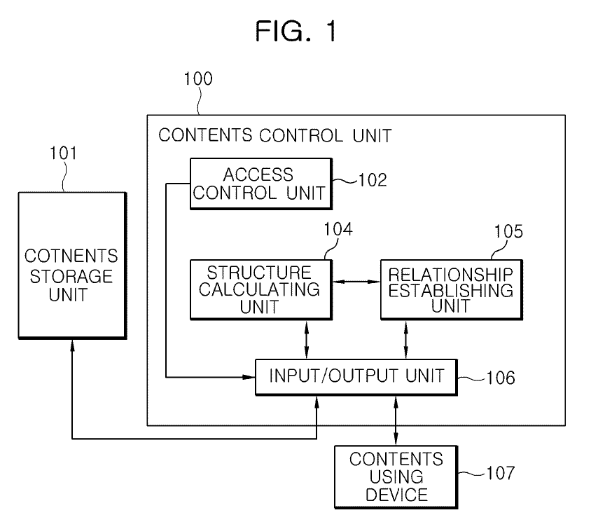

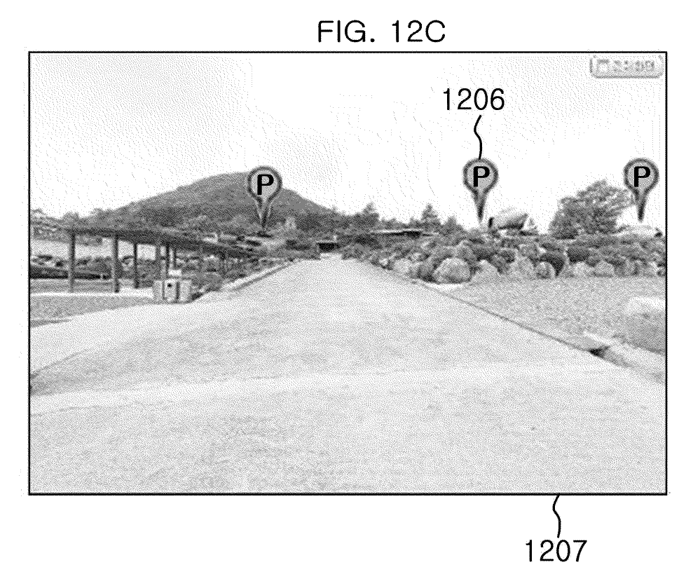

Hereinafter, referring to FIGS. 1 to 13, a preferred embodiment of the present invention will be described in detail.

FIG. 1 is a configuration diagram of an apparatus for managing hybrid contents generated by combining multimedia information and geospatial information according to an embodiment of the present invention.

Referring to FIG. 1, the apparatus for managing hybrid contents generated by combining multimedia information and geospatial information according to the embodiment of the present invention generates the hybrid contents which combine the multimedia information having a layer structure using an XML format and geospatial information having the layer structure using the XML format and includes a contents control unit 100 controlling input/output with a contents using device 107 and a contents storage 101 storing the multimedia information having the layer structure, the geospatial information having the layer structure, or the hybrid contents generated by the contents control unit 100.

Further, the contents control unit 100 includes an input/output unit 106 that is connected to the contents storage 101 or the contents using device 107 to take charge of inputting/outputting the hybrid contents, a structure calculating unit 104 that establishes the structure of the hybrid contents on the basis of the multimedia information and the geospatial information received from the input/output unit 106, a generation unit 103 that generates the hybrid contents in a format to facilitate storing and using the hybrid contents on the basis of the establishment of the structure calculating unit 104, and a relationship establishing unit 105 that is connected to the input/output unit 106 and the structure calculating unit 104 to establish and provide a relationship of a plurality of hybrid contents. The input/output unit 106 can be constituted by a wired/wireless communication device that can transmit and receive data to and from other devices including examples of the contents storage 101 and the contents using device 107 by using the Internet or other wired/wireless communication networks. Further, the contents control unit 100 can be constituted by one server computer which can contracture a database or a plurality of server computers connected through a communication network.

Hereinafter, the hybrid contents controlled and used according to the embodiment of the present invention are preferably defined in the XML format. The hybrid contents can be stored in the contents storage 101 in plural and as one example, can include a reference for contents connected to the outside, such as a multimedia file, a GML (XML based geospatial information generation language) by defining the structure and description of the hybrid contents in accordance with the XML format as an ASCII file of the XML format as it is. As another example, a compressed file format may include the ASCII file format and a format in which the external contents such as the multimedia file and the GML are together stored.

The contents storage 101 as a database server stores the multimedia information which exists in web sites or other communication networks or generated by user's multimedia photographing and generating devices such as a camera, etc., the geospatial information measured by a geospatial information measuring device including a global positioning system (GPS) measuring device, the hybrid contents acquired by combining the multimedia information and the geospatial information, etc. The contents storage 101 may be a computer for a general or special purpose, a recording medium, etc.

The multimedia information having the layer structure includes multimedia information stored in different layers by a structure having the XML format. A plurality of files may exist in accordance with each layer structure. The multimedia information can use a file format including txt (text file), doc (word program document of MS), hwp (word program document of HANSOFT), xml or html type text information and a file format including ASF (advanced streaming format), AVI (audio video interleave), BMP (bitmap), CDR (Coreldraw data file which is a graphic program), CGM (computer graphics metafile), CMX (corel presentation exchange), DCX (multiple page graphics PCX file), DRW (graphic file for designer program of Micrographics), EMF (enhanced meta file), GIF (graphics interchange format), IFF (amige interchange file format), JPG/JPEG (joint picture experts group), KDC (photographing image file used in Kodak digital camera), LBM (graphic file format used in deluxe paint of Electronic Art), MOV/QT (moving picture file format of Apple Computer), MPG/MPEG (moving picture experts group), PCD (Kodak photo CD), PCT/PICT (image file format prepared by Apple Computer), PCX (graphic file used in PC Paintbrush software of Zsoft), PIC (Lotus picture file), PNG (portable network graphics), PSD (image file used in photoshop of Adobe), RA/RAM/RMM/RM (multimedia streaming data file used in real player in Real Network), RLE (run-length encoding), TGA (targa graphic format of Truevision), TIF/TIFF (tag image file format), WMF (windows meta file), WPG (wordperfect graphic file), etc. The geospatial information may include a file format which can be read or stored by the computer including geospatial information of a text format directly stored in a memory of the database and NMEA-0183, GML, and GPX (GPS eXchange Format) which is the ASCII text code format in which the GPS format can be stored in the database.

The contents using device 107 is a device provided to allow the user to use the hybrid contents. The contents using device 107 includes a general computer, a server computer, an expert computer manufactured for a special purpose, a notebook computer, a mobile phone, a portable multimedia player (PMP), a TV, a camera, a camcorder, and other multimedia generating devices which can be communicated in a wired/wireless method.

Hereinafter, a detailed configuration example of the apparatus for controlling the hybrid contents and a method for controlling the hybrid contents which combine the multimedia information and the geospatial information will be described.

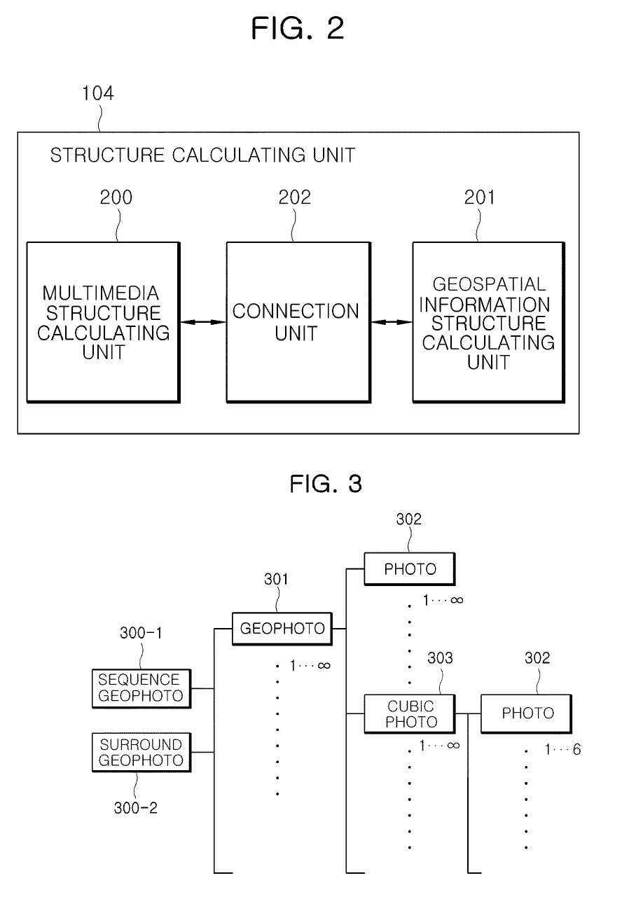

First, the input/output unit 106 receives the multimedia information and the geospatial information required to generate the hybrid contents from the contents storage 101. The structure calculating unit 104 that receives the multimedia information and the geospatial information from the input/output unit 106 generates the hybrid contents by a device or a system shown in FIG. 2. FIG. 2 shows a configuration example of the structure calculating unit 104 of the hybrid contents generating an XML-format hybrid contents data base structure which is an important characteristic of the present invention. The structure calculating unit 104 according to the embodiment of the present invention includes a multimedia structure calculating unit 200 forming an XML-format multimedia structure by receiving the multimedia information having the layer structure which is received from the input/output unit 106, a geospatial information structure calculating unit 201 forming an XML-format geospatial information structure by receiving geospatial information having the layer structure which is received from the input/output unit 106, and a connection unit 202 connecting a multimedia structure formed by the multimedia structure calculating unit 200 with a geospatial information structure formed by the geospatial information structure calculating unit 201, which corresponds to the multimedia structure, respectively.

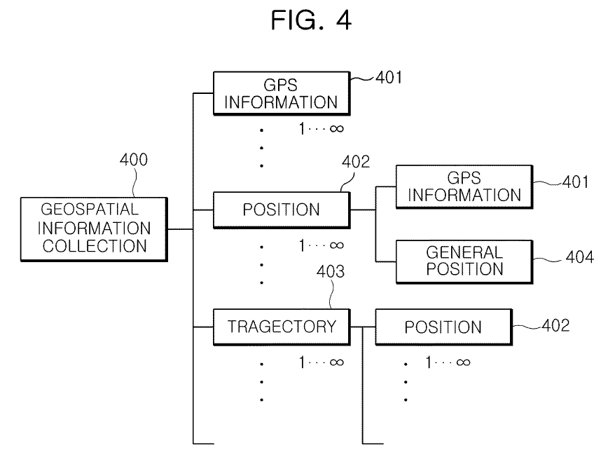

FIG. 3 shows an example of multimedia information having a layer structure structured in the XML format. In the embodiment, a multimedia structure can be constituted by a photo 302 which is a basic still photo photographable by image devices such as a digital camera, a camcorder, a mobile phone, etc., a cubic photo 303 connecting the photos acquired by photographing one object on a cubic plane (that is, photographed dimensionally in six directions), a geophoto 301 that which can express a planar or 3-dimensional image of an area or a space by a combination of a plurality of photos 302 and a plurality of cubic photos 303, a sequence geophoto 300-1 which can express a scenery of a predetermined street in a panorama or moving picture format of the photo at all once or along the path as time elapses by connecting a plurality of geophotos 301 along the time or a predetermined path, or a surround geophoto 300-2 which expresses the plurality of geophotos acquired by photographing one photographing target (which may include area, space, object, etc.) in multiple directions in the panorama or moving picture format of the photo as described above.

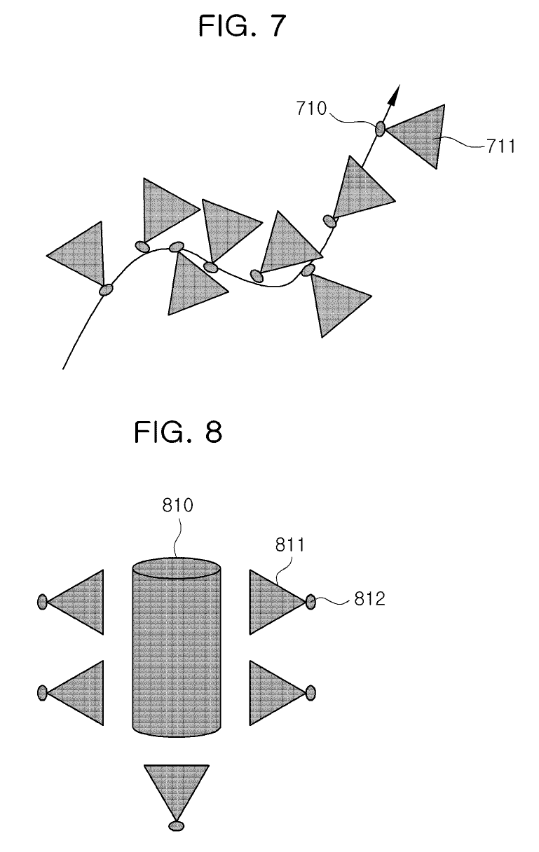

FIG. 6 shows an example of the cubic photo 303. Referring to FIG. 6, the cubic photo 303 is constituted by a collection of photos 302 acquired by photographing the inside of a building in six directions at one position and since each of these photos includes file information and six photos are thus structured by being connected by the cubic photo 303 in the XML format, the cubic photo 303 has a structure to combine the plurality of photos 302 without using another file format or another concept and as a result, a combination thereof is easy and in addition, since another file does not need to be created, it is efficient to generate and control the cubic photo 303.

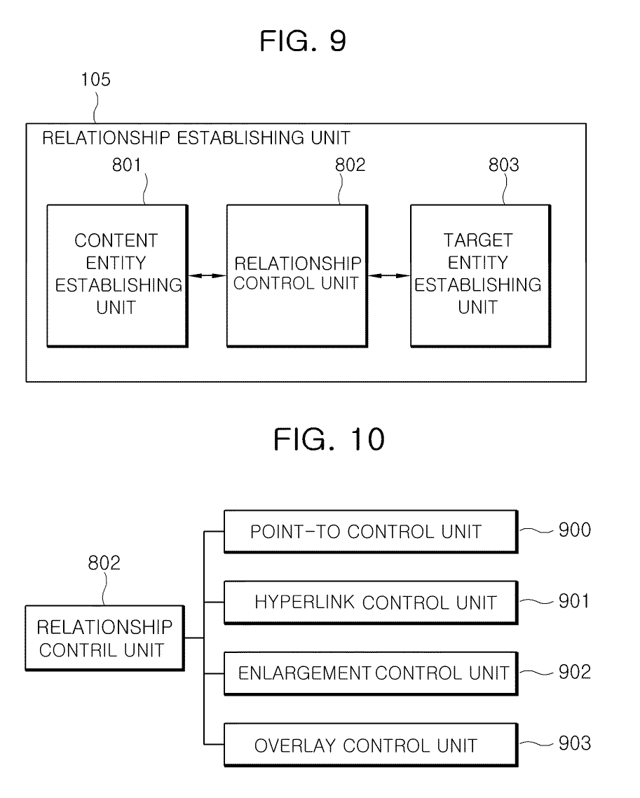

FIG. 7 shows an example of the sequence geophoto 300-1. Referring to FIG. 7, the sequence geophoto 300-1 is acquire by structuring and connecting parts 711 photographing a plurality of different objects photographed at a plurality of different positions or different times, that is, a plurality of geophotos 301 in the XML format. In the same manner as the cubic photo 303, since the plurality of geophotos 301 are also constituted by the plurality of photos 302 or the plurality of cubic photos 303, the sequence geophoto 300-1 is also structured by combining the plurality of geophotos 301, and the structuring can be integrated and controlled in the XML format, different files does not need to be used and the compatibility, controllability, and usability of the sequence geophoto 300-1 are very high.

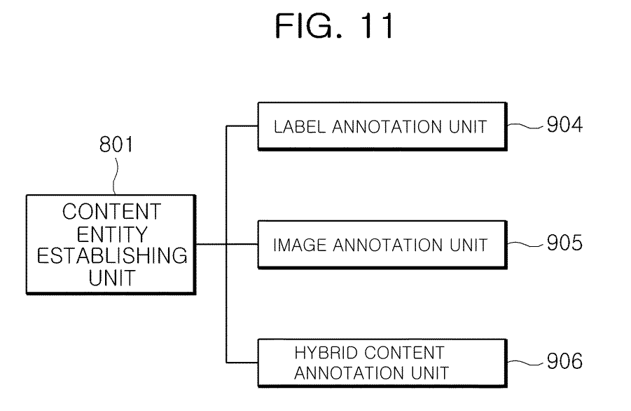

FIG. 8 shows an example of the surround geophoto 300-2. Referring to FIG. 8, the surround geophoto 300-2 is acquire by structuring and connecting different directions or parts 812 for a plurality of objects 810 photographed at different positions 811 or different times, that is, the geophoto 301 for a plurality of same objects 810 in the XML format. In the same manner as the sequence geophoto 300-1, since the plurality of geophotos 301 are also constituted by the plurality of photos 302 or the plurality of cubic photos 303, the surround geophoto 300-2 is also structured by combining the plurality of geophotos 301, and the structuring can be integrated and controlled in the XML format, different files do not need to be used and the compatibility, controllability, and usability of the surround geophoto 300-2 are very high.

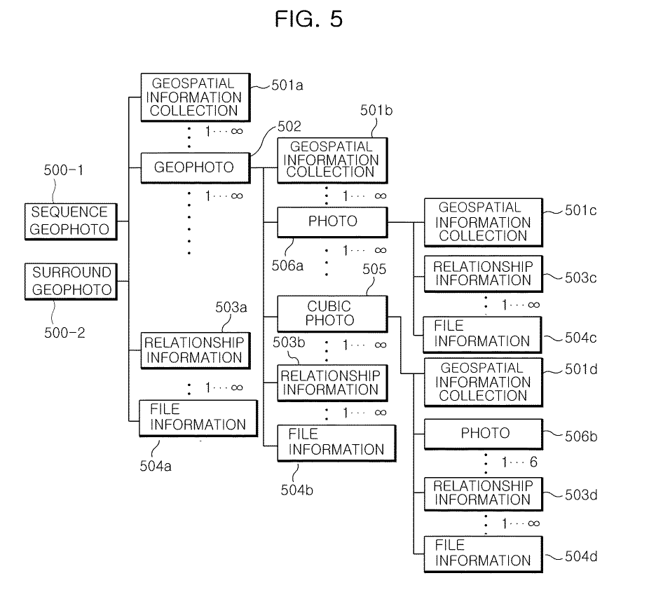

FIG. 4 shows an example of geospatial information having a layer structure structured in the XML format.

Referring to FIG. 4, a geospatial information structure can include GPS information 501 and general coordinate information 504 collected by the external server. The GPS information 501 may include longitude, latitude, seal level, azimuth, angle, magnetic direction, velocity, time, etc. The GPS information 501 can be acquired in the NAMEA specification format and can be inter-converted to the GPX format so as to express GPS data in the XML format. Further, the general coordinate 504 including general velocity, acceleration, azimuth, altitude above sea level, etc. can also be collected through the external server, etc.

Further, the geospatial information structure can include positional information 502 including the GPS positional information 501 and the general coordinate information and trajectory information 503 including the plurality of positional information 502 and expressing a change or connection of each position. The geospatial information structure can include a structure of a geospatial information collection 500 which is a collection of a structure including the plurality of GPS information 501, the positional information 502, and the trajectory information 503, as the largest concept of the geospatial information structure.

The geospatial information structure calculating unit 201 is connected with the multimedia structure calculating unit 200 by the connection unit 202 and the connection unit 202 serves to connect collections of the geospatial structures corresponding to the multimedia structures analyzed by the multimedia structure calculating unit 200 and the geospatial information structure calculating unit 201, respectively. The connected collections of the multimedia structure and the geospatial structure are transferred to the generation unit 103. The generation unit 103 generates a file in a format (a format including a reference for contents connected to the outside, such as the multimedia file, a GML (XML based geospatial information generation language) by defining the structure and description of the hybrid contents in accordance with the XML format as an ASCII file of the XML format as it is or a format in which the ASCII file format and the external contents such as the multimedia file and the GML are together stored as the compress file format) storable in the contents storage 101 and transmits the file to the input/output unit 106.

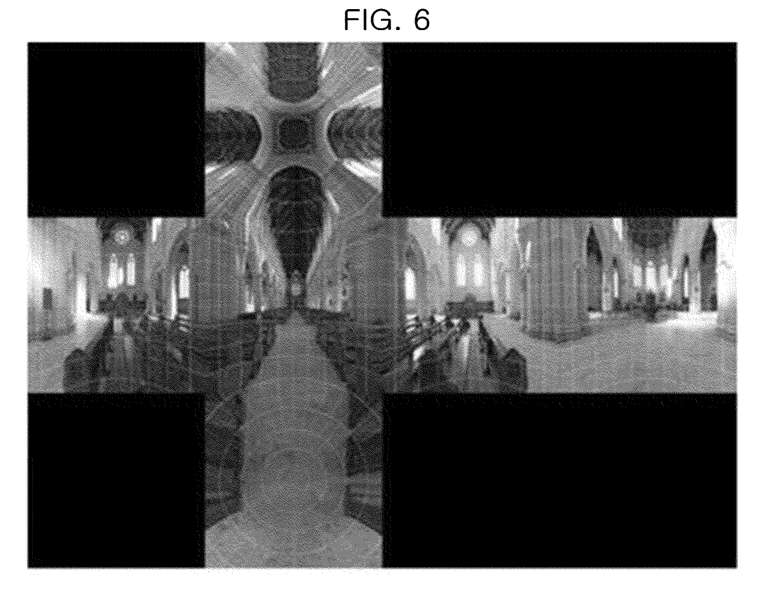

FIG. 5 schematically shows a combination pattern and a file format of the multimedia structure and the geospatial structure completed by the connection unit 202 and the generation unit 103. Referring to FIG. 5, geospatial information collection (position of photo, time, etc.) 501c corresponding to a photo 506a which is the smallest multimedia structure is connected to the photo 506a and a plurality of relationship information 503c with a plurality of different hybrid contents established by the relationship establishing unit 105 is connected to the geospatial information collection 501c. A cubic photo 505 includes six photos 506b. A geospatial information collection (connection relationship between the position of a photo, a time, and a direction of the photo) 501d on each of all the cubic photos or the photos 506b is connected to the cubic photo 505 and a plurality of relationship information 503d is also connected to the cubic photo 505. A geophoto 502 includes a plurality of photos 506a or a plurality of cubic photos 505. The geospatial information collection (the position of each photo, time, direction, volume and trajectory of the space, etc.) 501b on all geophotos, each photo 506a, or each cubic photo 505, is connected to the geophoto 502 and the plurality of relationship information 503b is also connected to the geophoto 502. A sequence geophoto 500-1 and a surround geophoto 500-2 which are the top-level concept structure include the plurality of geophotos 502. The geospatial information collection (the position of each photo, time, direction, volume of the space, a connection sequence of the photos, space flow trajectory information, etc.) 501a on all the sequence geophotos 500-1 or all the surround geophotos 500-2 or each geophoto 502) is connected to the sequence geophoto 500-1 and the surround geophoto 500-2. Further, the plurality of relationship information 503a is also connected to the sequence geophoto 500-1 and the surround geophoto 500-2.

As shown in FIG. 5, even in each structure of the hybrid contents, the collections of the multimedia information having the layer structure and the geospatial information corresponding to the multimedia information are connected to each other in a structure having top-level and bottom-level concepts. Further, in the case of the relationship of the plurality of hybrid contents, the hybrid contents are also preferably connected in the XML format. Since the hybrid contents are generated by the structuring and the hybrid contents are stored in the contents storage 101 in the above-mentioned two formats (a format including a reference for contents connected to the outside, such as the multimedia file, a GML by defining the structure and description of the hybrid contents in accordance with the XML format as an ASCII file of the XML format as it is or a format in which the ASCII file format and the external contents such as the multimedia file and the GML are together stored as the compress file format), the hybrid contents which combine the multimedia information and the geospatial information according to the embodiment of the present invention do not change the file format or contents of the original multimedia information or the geospatial information. Accordingly, it is possible to generate the hybrid contents only by simply changing the XML structure and simply operating the XML language and it is advantageous in that the change and transfer, relationship establishment, or analysis of the hybrid contents are very easy.

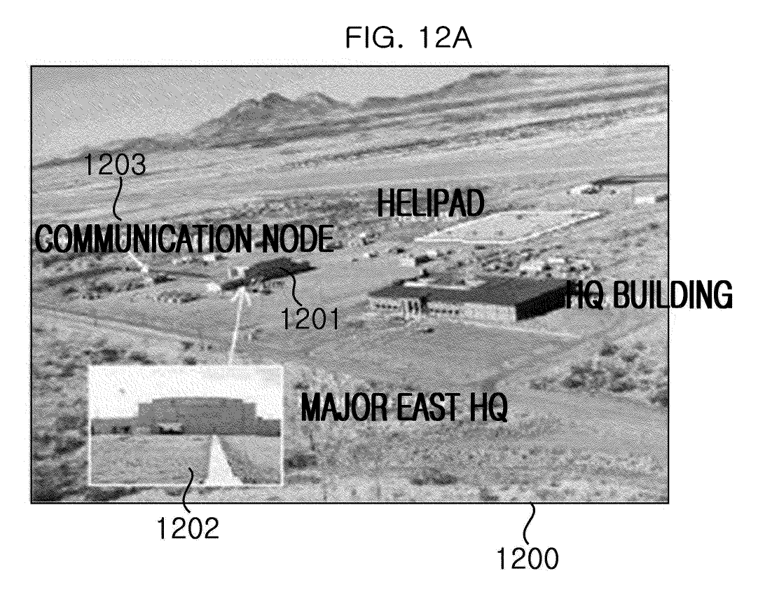

Referring to FIG. 9, a detailed configuration example of the relationship establishing unit 105 which is another important characteristic of the present invention shown in FIG. 1 is shown.

The relationship establishing unit 105 can include a target entity establishing unit 803 that designates all or some of the hybrid contents or the contents such as the multimedia information having the layer structure generated by the contents control unit 100 and define the designed contents as one entity, a content entity establishing unit 801 that defines as the entity multimedia information or the content of the hybrid contents such as the text, the image, the moving picture, etc. which is information (information indicating information such as a place, a time, etc. of the target entity, a detailed content of the target entity, and other information related to the target entity) corresponding to the designed target entity through a predetermined relationship, and a relationship control unit 802 that connects content entities corresponding to the target entities to the target entities by using a plurality of methods in accordance with the relationship between the entities.

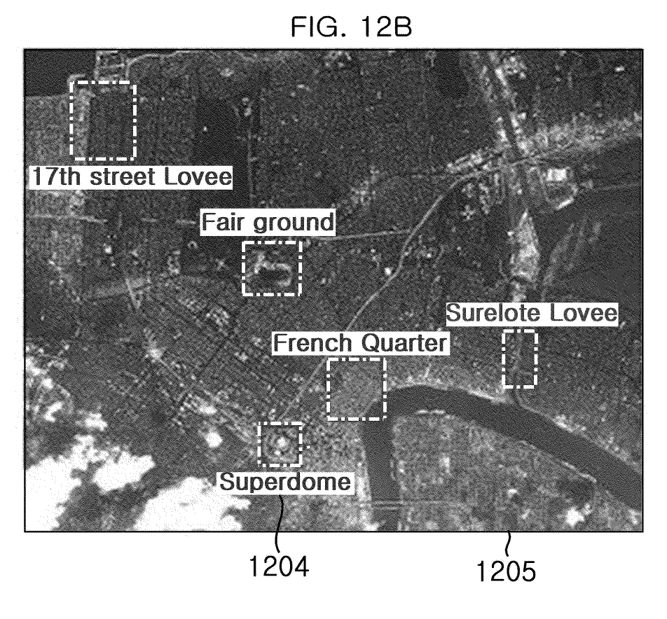

When the target entity is defined, the content entity establishing unit 801 serves to define the content as the entity by searching the hybrid contents designated by the target entity or the content of the hybrid contents through a web page or other searching devices by using the Internet or other wired/wireless communication network or directly receiving the hybrid contents or the content of the hybrid contents through the user's contents using device 107. The content entities may be stored in a label annotation portion 904 representing a text annotation, an image annotation portion 905, and a hybrid contents annotation portion 906 depending on their properties as shown in FIG. 10.

The relationship control unit 802 performs a control function of connecting the content entity with the target entity by using any one of a point-to control unit 900, a hyperlink control unit 901, an enlargement control unit 902, and an overlay control unit 903. One or more methods may be duplicately used depending on the content of the annotation.

In the case of the point-to control unit 900, the contents entity corresponding to the target entity is directly displayed on a display window and basically, the content entity such as an annotation of a predetermined target entity on the contents is defined by using a designation mark such as an arrow, etc. When the designation mark is not defined, the content entity is displayed next to the target entity.

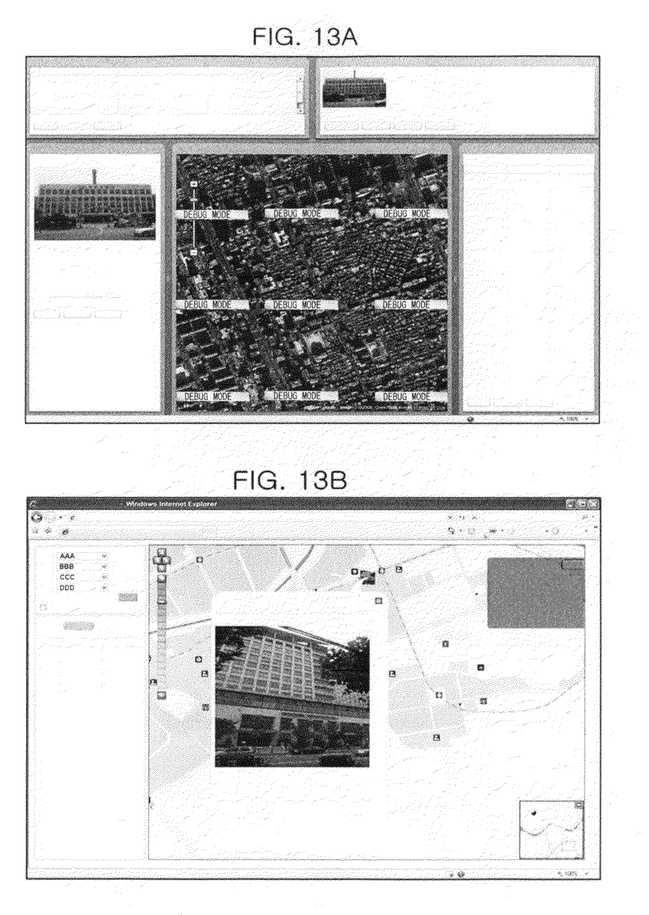

FIG. 12A shows an example of the geographical photo among the hybrid contents connected by the relationship establishing unit 105. Referring to FIG. 12A, map contents 1200 constituted by the photo is provided and a target entity 1201 of geographical photo contents 1200 are provided which designates a predetermined building of the geographical photo contents 1200 and defines the building as the target entity. Further, a first content entity 1203 as text information including name information of the target entity 1201 is defined and in addition, a magnified photo as a front photo of the building serving as the target entity 1201 and a second content entity 1202 representing another name are defined. Further, content entities (having no identification number) representing names of other buildings are displayed in other geographical photo contents 1200.

In FIG. 12A, some of the geographical photo contents 1200 are defined as the target entity 1201, and the first content entity 1203 is defined as a label annotation and the second content entity 1202 is defined as a hybrid contents annotation combining the label annotation with an image annotation. Further, the relationship between the target entity 1201 and the first content entity 1203 uses the point-to control unit 900 directly expressing the name in the geographical photo contents 1200 by using the arrow. The relationship between the second content entity 1202 and the target entity 1201 uses both the point-to control unit 900 and the enlargement control unit 902. Other label annotations (having no identification number) uses the point-to control unit 900 without the arrow.

FIG. 12B shows an example in which names of some of the geographical photo contents 1205 as the label annotation by using the point-to control unit 900 without the arrow by defining some of the geographical photo contents 1205 as the target entity (part where the label annotation is displayed) (having no identification number) and defining the content entity (1204 and text information without the identification number).

In the case of the hyperlink control unit 901, an address of the web page, etc. where the content entity corresponding to the target entity is stored or displayed is linked through the communication network, such as contents of the web page, etc. represented by an address are displayed.

FIG. 12C shows an example of using the hyperlink control unit 901. Referring to FIG. 12C, some of the geographical photo contents 1207 are defined by using the target entity (having no identification number). In addition, the content entity is not displayed and can represent the text information, the image information, or the hybrid contents information depending on the property of the content entity. The target entity (having no identification number) is designated by a mark 1206 similar as a small speech balloon and when a user clicks on the balloon, a web page containing geospatial information, multimedia information, etc. related to the target entity is connected. The relationship between the target entity and the content entity uses the hyperlink control unit 901. Of course, the relationship between the target entity and the content entity may use the enlargement control unit 902 or the overlay control unit 903 in addition to the hyperlink control unit 900.

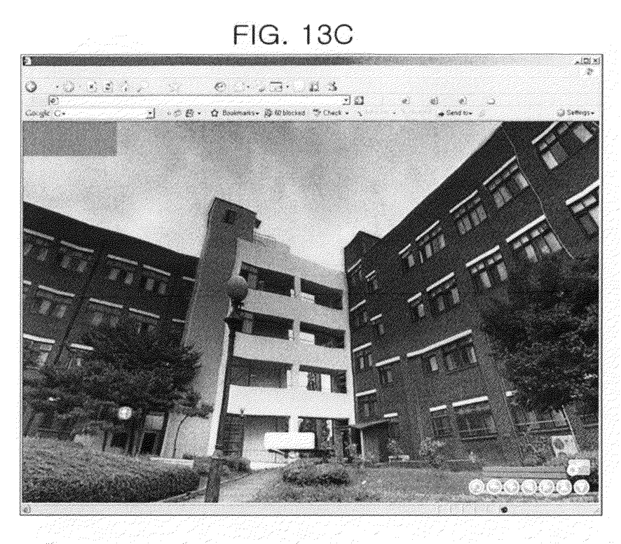

The apparatus and method for controlling the hybrid contents which combine the multimedia information and the geospatial information according to the embodiments of the present invention may be managed by a provider or serviced to the user through the contents using device 107 by using the Internet and other wired/wireless communications. FIG. 13A shows an example of a program to allow a control unit to control hybrid contents by using a web server or other communication networks. FIGS. 13B and 13C show an example in which a hybrid contents providing service can be provided to the user through the web page. By this configuration, the control unit and the user can efficiently control and use the content of the hybrid contents, and the control and service type can be implemented through the wired/wireless communication network including the Internet and a database management device including the computer server.

In yet another embodiment of the present invention, since the file information such as a file preparation time, a preparer, access right information, etc. of the multimedia information, the geospatial information, or the hybrid contents file combining the multimedia information and the geospatial information may need to be controlled, it is preferable that the contents control unit 100 further includes an access managing unit 102 that is connected to the input/output unit 106 to control the information of the files.

Further, in yet another embodiment, the multimedia information having the layer structure and the geospatial information having the layer structure may be provided in correspondence with an act of the access managing unit 102 and a structure corresponding to the information of the file may be provided on the structure of structured hybrid contents. Referring to FIG. 5, file information 504a, 504b, 504c, and 504d are provided in each hybrid contents file and information including copyrighter information, a generation time, a password, etc. may be included in the file information 504a, 504b, 504c, and 504d. The file information 504a, 504b, 504c, and 504d are provided with being included in the multimedia information having the layer structure or the geospatial information having the layer structure or only the file information 504a, 504b, 504c, and 504d are integrally controlled by the access managing unit 102 and thus, can be together combined when the structure calculating unit 104 and the generation unit 103 generate the hybrid contents structure.

The embodiment does not limit the appended claims of the present invention and includes contents of equivalent apparatus and method that serve as the same function as the embodiment.

What is claimed is:

1. An apparatus for managing hybrid contents generated by combining multimedia information and geospatial information, comprising:
an input/output unit that is connected with a contents storage unit and a contents using device to control input/output of the hybrid contents;
a structure calculating unit that generates the hybrid contents having a layer structure using an XML format by interconnecting the multimedia information having the layer structure using the XML format provided from the input/output unit and the geospatial information having the layer structure using the XML format; and
a relationship establishing unit that is connected with the input/output unit or the structure calculating unit to establish and provide the relationship of the multimedia information having the layer structure, the geospatial information having the layer structure, and the hybrid contents.

2. The apparatus for managing hybrid contents according to claim 1, further comprising:
an access managing unit that is connected to the input/output unit to manage a usage right of the hybrid contents.

3. The apparatus for managing hybrid contents according to claim 1, wherein the structure calculating unit includes:
a multimedia structure calculating unit that manages the multimedia information having the layer structure;
a geospatial information structure calculating unit that manages the geospatial information having the layer structure;
a connection unit that generates the hybrid contents by combining the geospatial information having the layer structure corresponding to the multimedia information having the layer structure.

4. The apparatus for managing hybrid contents according to claim 1, wherein the multimedia information having the layer structure has a layer structure including at least one of a photo, a cubic photo including the plurality of photos, a geophoto including the plurality of photos or the plurality of cubic photos, a sequence geophoto including the plurality of geophotos at different places or different times, and a surround geophoto including the plurality of geophotos about the same object.

5. The apparatus for managing hybrid contents according to claim 1, wherein the geospatial information having the layer structure has a layer structure including at least one of GPS information, positional information including the GPS information or general coordinate information, trajectory information including the plurality of positional information, and a geospatial information collection including the plurality of GPS information, the plurality of positional information, and the plurality of trajectory information.

6. The apparatus for managing hybrid contents according to claim 1, wherein the relationship establishing unit includes:
a target entity establishing unit that defines a target entity designating all or some of the hybrid contents received from the input/output unit;
a content entity establishing unit that defines a content entity based on at least one of text information, the multimedia information having the layer structure received from the input/output unit, the geospatial information having the layer structure, and the hybrid contents; and
a relationship control unit that controls the relationship between the target entity and the content entity corresponding to the information of the target entity.

7. The apparatus for managing hybrid contents according to claim 6, wherein the relationship control unit includes at least one of a point-to control unit that defines the contents entity which can directly display the target entity on the hybrid contents, a hyperlink control unit that connects the target entity and the content entity to an external communication network, an enlargement control unit that enlarges the content of the target entity, and an overlay control unit that display only the target entity.

8. The apparatus for managing hybrid contents according to claim 6, wherein the content includes at least one of a label annotation, an image annotation, and the hybrid contents.

9. A method for managing hybrid contents generated by combining multimedia information and geospatial information by a contents control unit, comprising:
receiving multimedia information having a layer structure using an XML format and geospatial information having a layer structure using the XML format from a contents storage unit;
generating the hybrid contents which combine the multimedia information having the layer structure and the geospatial information having the layer structure;
inputting/outputting the hybrid contents with the contents storage unit or a contents using device; and
establishing the relationship of the multimedia information having the layer structure, the geospatial information having the layer structure, or the hybrid contents.

10. The method for managing hybrid contents according to claim 9, wherein generating the hybrid contents includes:
analyzing the multimedia information having the layer structure;
analyzing the geospatial information having the layer structure; and
generating the hybrid contents by combining the multimedia information having the layer structure to the geospatial information having the layer structure corresponding to the multimedia information having the layer structure.

11. The method for managing according to claim 9, wherein the multimedia information having the layer structure has a layer structure including at least one of of a photo, a cubic photo including the plurality of photo, a geophoto including the plurality of photos or the plurality of cubic photos, a sequence geophoto including the plurality of geophotos at different places or different times, and a surround geophoto including the plurality of geophotos about the same object.

12. The method for managing hybrid contents according to claim 9, wherein the geospatial information having the layer structure has a layer structure including at least one of GPS information, positional information including the GPS information or general coordinate information, trajectory information including the plurality of positional information, and a geospatial information collection including the plurality of GPS information, the plurality of positional information, and the plurality of trajectory information.

13. The method for managing hybrid contents according to claim 9, wherein establishing the relationship includes:
defining a target entity designating all or some of the hybrid contents received from the input/output unit;
defining a content entity based on at least one of text information, the multimedia information having the layer structure received from the input/output unit, the geospatial information having the layer structure, and the hybrid contents; and
controlling the relationship between the target entity and the content entity corresponding to the information of the target entity.

14. The method for managing hybrid contents according to claim 13, wherein controlling the relationship between the target entity and the content entity corresponding to the information on the target entity includes at least one of a point-to control unit that defines the contents entity which can directly display the target entity on the hybrid contents, a hyperlink control unit that connects the target entity and the content entity to an external communication network, an enlargement control unit that enlarges the content of the target entity, and an overlay control unit that display only the target entity.

15. The method for managing hybrid contents according to claim 13, wherein in defining the content entity, the content includes at least one of a label annotation, an image annotation, and the hybrid contents.
